(19) United States
(12) Patent Application Publication
(10) Pub. No.: US 2002/0124702 A1
(43) Pub. Date: Sep. 12, 2002

(54) Water jet web slitting apparatus

(75) Inventors: Roman C. Caspar, Beaconsfield (CA); Dieter H. Hilker, Mascouche Heights (CA)

Correspondence Address: CRAIG WILSON, 2570 MATHESON BLVD. EAST, SUITE 211, MISSISSAUGA, ON, L4W 4Z3, CA

(73) Assignee: Paprima Industries Inc., Montreal (CA)

(21) Appl. No.: 10/083,528

(22) Filed: Feb. 27, 2002

(30) Foreign Application Priority Data
Mar. 6, 2001 (CA) 2,339,438

(51) Int. Cl. B26F 3/00

(52) U.S. Cl. 83/177; 83/100; 83/425.3; 83/440; 83/454

(57) ABSTRACT

A water jet web slitting apparatus slits a web at a plurality of locations across the web into webs of smaller width in a winder. The water jet web slitting apparatus utilizes a water jet cutter to slit the web. The water jet cutter has a support plate with a pattern of suction apertures located surrounding the cutting aperture of the water jet cutter through which negative pressure is applied to hold the web against the support plate adjacent the water jet cutting apparatus and to prevent the web from fluttering or moving relative to the support plate notwithstanding whether the web is travelling or temporarily at a stopped position. This permits for the water jet to be run continuously without having to be turned off and restarted when the web travel is temporarily stopped and started again because the continually running jet does not re-wet the surface of the web or the edges cut into the web.

### FIELD OF THE INVENTION

The present invention relates to a water jet web slitting apparatus for slitting a web normally travelling in a first direction or remaining stationary relative to the slitting apparatus. In particular it relates to a water jet slitting apparatus that cuts the travelling web and does not wet the web during stoppage in web travel.

### BACKGROUND OF THE INVENTION

In the papermaking industry, knives or water jets are commonly employed to cut through the traveling web or sheet. The knives and water jets are used in edge trimming, slicing, cross-cutting, and tail cutting applications within the papermaking machine. However, water jet cutters have rarely been used to as slitters in a re-winder machine where a wound web of paper is un-wound, slit in longitudinal directions and rewound into webs of reduced width.

One reason for a limited use of water jets to slit the web at the re-winder is due to the fact that the web travel is stopped when a new reel is loaded at the unwind section of the re-winder or the web is spliced. Portions of the paper adjacent the water jet can be seriously damaged if the paper is re-wetted by the water jet.

While one possible solution might be to turn the water jet off for every stoppage in web travel, this solution is not practical since the jets must be re-started causing a momentary web surface splash before full pressure is achieved. Furthermore, any movement of the web in the direction of web travel effected by changes in web tension while the water jet is off causes an interruption in the cut line in the web. An interruption of the cut line results in tearing of the paper web when the rolls are separated.

A water jet cutting head currently in use in the papermaking industry typically includes a base plate having a cover plate defining a chamber. The cover plate has one large upstream circular aperture through which air is drawn to hold the sheet against the cover plate. A second circular aperture is located downstream in the direction of sheet travel relative to the first circular aperture. A water jet is emitted through the second aperture to cut the sheet. Air is drawn through the first aperture and the second aperture by a hose contained in the chamber. The hose passes through the base plate to remove the air from the chamber and maintain a vacuum. While such a described water jet cutting head has good cutting performance characteristics, it is unsuitable as a slitter head for a re-winder.

A water jet cutting apparatus, as disclosed in U.S. Pat. No. 6,021,699 issued Feb. 8, 2000 to Roman Caspar, was developed for cutting strip into the edge of a traveling web where an asymmetrical aperture pattern is utilized only on one side of the water jet to discriminately support only that portion of the web to be further processed within the papermaking machine or the sheet processing machine while discarding the strip trimmed from the web. Such a water jet cutter would not function as a slitter on a re-winding machine because it would be subject to the potential wetting problems noted above.

Accordingly, there is a need to provide a water jet cutting device that can be utilized in the dry end of a papermaking machine and does not wet the web during temporary stoppages in web travel.

### SUMMARY OF THE INVENTION

The present invention relates to a water jet web slitting apparatus for slitting a web into a plurality of webs of smaller width. In particular, the present invention utilizes a series of water jet cutters mounted on a support beam traversing the width of the beam and supported from the beam by a support arm. The water jet cutters cut through the travelling web to cut the web into the plurality of smaller webs. The present invention utilizes a support plate structure with the water jet cutter that continues to support the web in engagement with the plate when the web is travelling over the plate or is in a stopped position relative to the plate.

The water jet cutter has a water jet nozzle which preferably continues to emit the water jet through a cutting aperture in the support plate. This jet continues whether or not the web is travelling across the support plate. In order to support the web and prevent it from fluttering or moving relative to the water jet and the support plate, the support plate has a working surface area in which a plurality of apertures are located. The apertures also surround the water jet cutting aperture. These apertures are referred to throughout the specification as suction apertures because a negative pressure or suction is applied through these apertures to pull the web against the suction apertures and against the working surface area of the support plate. As a result, the web is held against the support plate while the water jet passes through the support plate and the web thereby cutting the web and forming new cut edges for the smaller webs. In the event that the web stops its travel over the support plate, the web is held firmly in place against the support plate both upstream and downstream in the direction of web travel relative to the cutting aperture. Also, the web cut edges downstream from the water jet cut are held firmly against the working surface area of the support plate and are not in direct alignment with the water jet because the jet penetrates or blasts a hole through the web with a high speed jet of extremely small diameter. This jet continues to pass through the web without touching the web when the web remains stationary and does not re-wet the web.

Preferably the suction apertures are arranged in a symmetrical pattern surrounding the water jet cutting aperture both upstream and downstream in the direction of web travel. The suction applied to the suction apertures may be chosen to cause the support plate to grab or hold the web against the plate upstream, downstream and on both sides of the water jet cutting aperture. Hence, the hole pattern arrangement of the present invention provides a uniform suction force about the cutting aperture preventing the cutting edges of the web and the web from fluttering relative to the working surface area.

The water jet web slitting apparatus, including the water jet of the present invention, may be utilized as a slitter on a re-winder machine where the web is to be slit into a plurality of webs and wound onto separate rolls. Further, because web travel is known to stop to permit separate rolls to be exchanged, the location of the cut is immaterial because it does not result in any damage to the web. For example, if the web is damaged by re-wetting, there is wasted web that has to be trimmed or discarded from the new separate rolls. The present invention is not subject to these problems.

In accordance with the present invention, the water jet web slitting apparatus comprises a plurality of water jet cutters. Each water jet cutter has a support plate having a working surface area against which the web is supported. The support plate has a cutting aperture passing through the working surface area and a predetermined number of suction apertures passing through the working surface area arranged in a pattern on both sides of the cutting aperture in a first direction of web travel. The cutter has a water jet nozzle located adjacent the cutting aperture for directing a water jet through the cutting aperture and away from the working surface area. The cutter has suction means for applying suction through the suction apertures to draw the web towards the suction apertures and into engagement with the working surface area whereby the web is supported by the support plate on upstream, downstream and both sides of the cutting aperture in the first direction of web travel. The suction applied by the suction means prevents fluttering movement of the web relative to the working surface area to permit the water jet passing through the cutting aperture to cut through the web to form cut edges and to prevent wetting of the web surface and cut edges notwithstanding whether the web is normally travelling in the first direction or is remaining stationary relative to the working surface area of the slitting apparatus.

It should be understood that the amount of suction applied to the suction apertures depends on the shape and size of the apertures which preferably are round. The cutting aperture is considerably smaller than the suction apertures because the dimension of the jet is relatively small and it is preferred that substantially no suction be applied through the cutting aperture. The water jet nozzle is preferably located closely adjacent the cutting aperture on the opposite side of the support place from the web to block the cutting aperture preventing suction from being applied to the cutting aperture. The smaller the cutting aperture, the better the jet cuts through the web and less are the risks of backsplash occurring. The cutting aperture may have a diameter in the range of 0.05 to 3 mm.

The working area is that area defined around the suction apertures on the support plate and in-between the suction apertures. The working area may extend further beyond the perimeter as defined by the suction apertures by an amount which would be proportional to the amount of suction applied through the suction apertures. In accordance with the present invention, the support plate preferably has a section downstream from the cutting aperture and in line therewith to which suction is not applied. It is across this section that the cut edges of the web pass.

The suction may be applied to the suction apertures by means of hoses applied directly to the suction apertures or by having an enclosed chamber located behind the support plate in which the water jet nozzle is mounted and from which a suction hose is attached to either the rear surface or side surfaces of the support plate to create a negative pressure within the chamber to draw air in through the suction apertures.

Preferably, the suction aperture pattern comprises a series of six suction apertures, four of which are located immediately prior to the cutting aperture in the downstream direction of the travel of the web and two apertures located downstream relative to the cutting aperture. The suction apertures are preferably aligned on either side of the cutting aperture whereby at least the downstream suction apertures relative to the cutting apertures have a land area or longitudinal working surface section that is not interrupted by the pattern of the suction apertures. This prevents any suction being applied to the web cut edges as the web travels past the cutting aperture. Alternatively, it should be understood that the present invention provides a water jet cutter which may be placed either above or at any angle not more than 90 degrees from the vertical relative to the travel of web.

### BRIEF DESCRIPTION OF THE DRAWINGS

For a better understanding of the nature and objects of the present invention reference may be had to the accompanying diagrammatic drawings in which:

FIG. 1 is a perspective view showing the water jet web slitting apparatus of the present invention adapted for slitting a web into a plurality of webs having smaller width by the use of the water jet cutter of the present invention;

FIG. 2 is a side view of the water jet cutting apparatus of the present invention;

FIG. 3 is a bottom view of the support plate utilized in the water jet cutting apparatus of the present invention; and

FIG. 4 is a top view of the support plate chamber mechanism of the water jet cutting apparatus of the present invention.

### DETAILED DESCRIPTION OF THE DRAWINGS

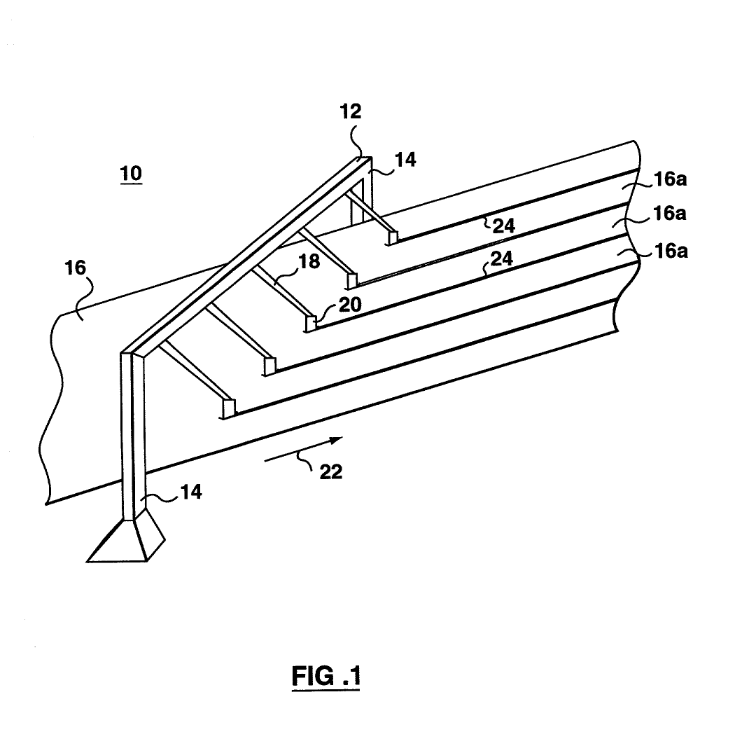

Referring FIG. 1, there is shown a water jet web slitting apparatus 10 having a support beam 12 and stands 14 for supporting the support beam 12. The support beam 12 spans across the width of the web 16. The support beam 12 includes a plurality of arms 18 which hold a water jet cutting apparatus or cutter generally shown at 20. It should be understood that the water jet cutting apparatus 20 include hoses and pneumatic controls (not shown) which will pass down the arms and across the beam so as to be supported away from the travelling web 16. In the present invention, the web travels in the first direction shown by arrow 22 and each of the cutters 20 slits the web 16 at slits or cut edges 24 so that the web 16 now has been cut into a plurality of separate webs 16a having a width which is less than the overall of the web 16.

It should be understood that this water jet web slitting apparatus 10 typically is utilized in a re-winder machine where a wound roll of paper is un-wound, slit in a longitudinal direction, and re-wound into webs of reduced width. The web 16 is slit by the water jet slitters 20 and the slits 24 become the new edges of each of the smaller webs 16a. The webs 16a are re-wound onto separate winding rolls (not shown). In the practice of the present invention, the web 16 normally travels in the direction of arrow 22 and is stopped from time to time to remove separate wound rolls from the downstream section of the re-winder.

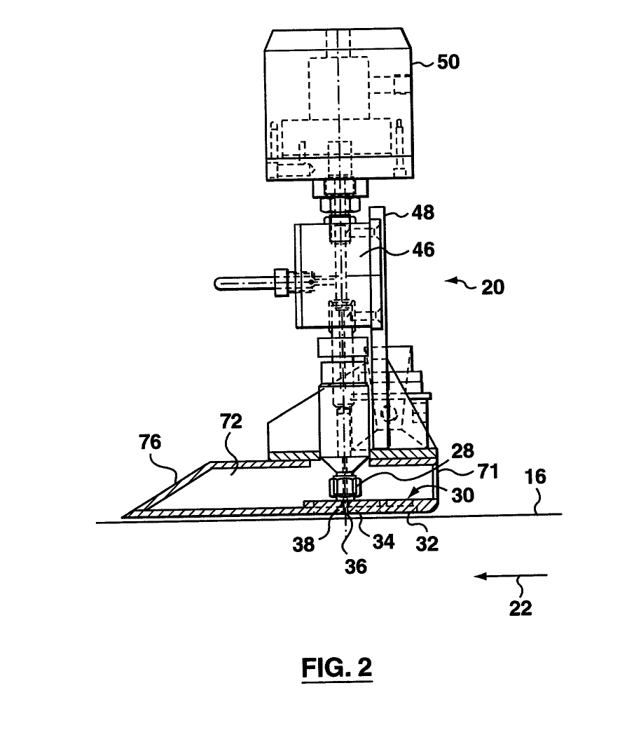

Referring to FIGS. 2, 3 and 4, the construction of each of the water jet cutters 20 for slitting slits 24 in web 16 is shown. The water jet cutter 20 has a nozzle 28 located within a chamber 30. The nozzle 28 is mounted relative to a support plate 32 behind a working surface area 34. A water jet 36 pushes through the aperture of cutting aperture 38 in the working surface area 34. Cutting aperture 38 has a preferred diameter of 0.08 to 3 mm. The nozzle 28 is positioned closely adjacent the cutting aperture to block the cutting aperture and prevent or limit suction being applied through cutting aperture 38.

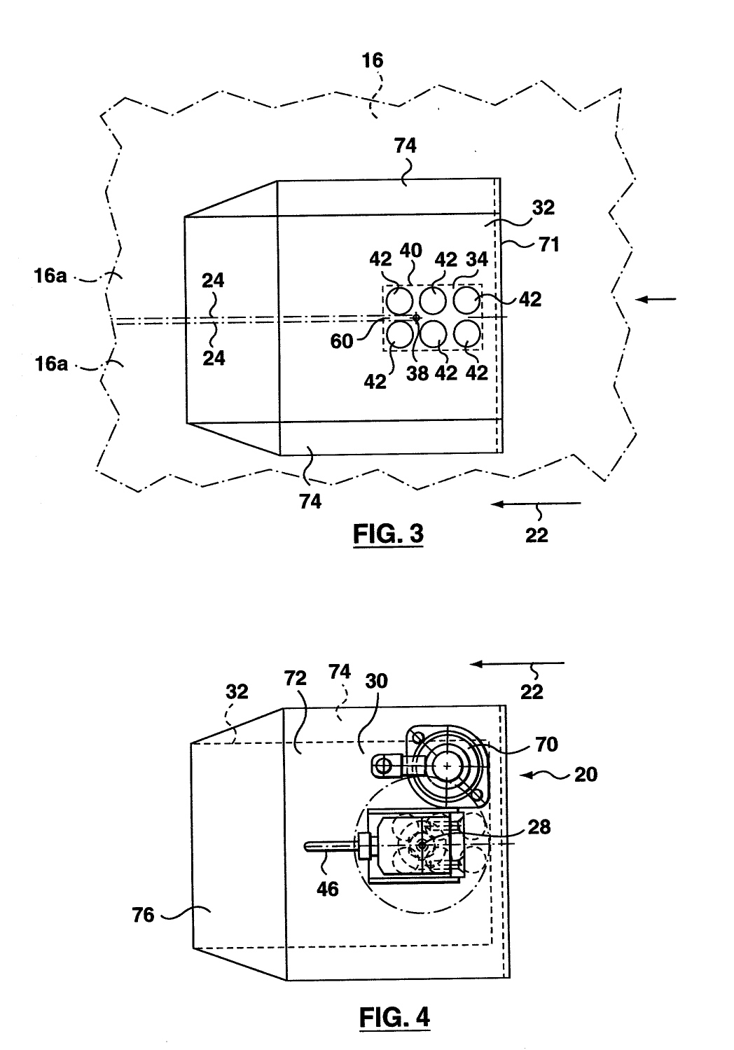

Referring to FIG. 3, the working surface area 34 is shown within the perimeter 40 in the dotted lines and surrounds the cutting aperture 38. Also located within the perimeter 40 of the working surface area 34 are a series of suction apertures 42. The suction apertures 42 are aligned in a symmetrical pattern of two rows of three apertures in the direction 22 of web travel. The suction apertures 42 are circular in shape and have a preferred diameter of 20 mm, which is considerably larger than the smaller diameter of cutting aperture 38. Each row of three suction apertures 42 is aligned in the direction 22 of web travel on opposite sides of the water jet cutting aperture 38. Furthermore, four suction apertures 42 are located upstream of the water jet cutting aperture 38 and two suction apertures 42 are located downstream in the direction 22 of web travel relative to the water jet cutting aperture 38. The suction apertures 42 hold the web 16 against the working surface area 34 to permit the water jet 36 to cut through the web 16.

The shape of the suction apertures 32 may vary from a circular shape, however for the purposes of the present invention circular apertures are preferred because cutting these holes is less costly and the suction applied across the aperture is relatively uniform. Two additional apertures 42 are positioned upstream than downstream of the water jet cutting aperture 38 insuring the working surface area 34 to grip or draw the web 16 against this working surface area 34 prior to cutting through the web.

The area 60 immediately downstream of the cutting aperture 38 between the suction apertures 42 provides a land of longitudinal working surface section that is not interrupted by the suction aperture pattern such that no suction is applied to the cut edges or slits 24 of the web 16a.

The apparatus 10 is further provided with a suction hose 70 shown in FIG. 4 which comes in through the rear wall or top wall 72 of the chamber 30 to draw or create a vacuum or negative pressure area within chamber 30 so that suction is drawn through the suction apertures 42.

The support plate 32 is separated from a top wall 72 by a front wall 71, side walls 74 and angled top or back wall 76. The side walls 74 preferably angle outwardly or diverge from each other as the side walls 74 extend away from the support plate 32 towards the top wall 72. Thus as the sheets or web 16 widens out, it passes smoothly underneath the cutting heads without catching. The back wall 76 is angled downwardly into the web as it extends from the top wall 72 to the support plate 32. The sloping back wall 76 improves air flow over the top wall 72 of air moving with the traveling web 16 as the web is drawn over support plate 32. The improved air flow is less turbulent reducing “low pressure” areas where dust particles might first collect.

The water jet cutter 20 further includes conduits 46 passing through the neck 48 and upper body 50 of the cutter for connection with the arms 18 of the beam 12.

It should be understood that the arms 18 of the beam 12 may be adjusted across the beam to adjust the width of the slots or the webs being cut from the master web 16. However, it is not a feature of the present invention that this adjustment is a continuous adjustment that occurs during the web cutting or slitting process. On the other hand, the position of the cutters 20 are adjusted prior to the cutting operation and remain in that position during the cutting operation for a given web 16 to be slit into smaller webs 16a.

It should be understood that alternative embodiments of the present invention may be readily apparent to a person skilled in the art in view of the above description for the preferred embodiments of this invention. Accordingly, the scope of the present invention should not be limited to the teachings of the preferred embodiments and should be limited to the scope of the claims that follow.

What is claimed is:

1. A water jet web slitting apparatus for slitting a web normally travelling in a first direction relative to the slitting apparatus and capable of remaining stationary relative to the slitting apparatus, the apparatus comprising:
a) a support plate having a working surface area against which the web is supported, the support plate having a cutting aperture passing through the working surface area and a predetermined number of suction apertures passing through the working surface area arranged in a pattern on both sides of the cutting aperture in the first direction of web travel;
b) a water jet nozzle located adjacent the cutting aperture for directing a water jet through the cutting aperture and away from the working surface area; and,
c) suction means for applying suction through the suction apertures to draw the web towards the suction apertures and into engagement with the working surface area whereby the web is supported by the support plate on upstream, downstream and on both sides of the cutting aperture in the first direction of web travel, and the suction applied by the suction means preventing fluttering movement of the web relative to the working surface area to permit the water jet passing through the cutting aperture to cut through the web to form cut edges and to prevent wetting of the web surface and cut edges notwithstanding whether the web is normally travelling in the first direction or is remaining stationary relative to the working surface area of the slitting apparatus.

2. The water jet web slitting apparatus of claim 1 wherein the pattern of suction apertures is uniform and substantially in a symmetrical pattern providing substantially uniform suction force on the web over the working surface area and around the cutting aperture.

3. The water jet web slitting apparatus of claim 1 wherein the working surface area has a longitudinal working surface section downstream from the cutting aperture in the first direction of web travel whereby limited suction is applied between the web cut edges.

4. The water jet web slitting apparatus of claim 1 wherein the suction apertures are considerably larger than the water jet cutting aperture.

5. A water jet web slitting apparatus for slitting a web normally travelling in a first direction relative to the slitting apparatus and capable of remaining stationary relative to the slitting apparatus, the apparatus comprising:
a) a support plate having a working surface area against which the web is supported;
b) the support plate having a cutting aperture passing through the working surface area whereby the web is supported by the support plate on upstream, downstream and on both sides of the cutting aperture in the first direction of web travel;
c) a water jet nozzle located adjacent the cutting aperture for directing a water jet through the cutting aperture and away from the working surface area and the water jet nozzle substantially blocking the cutting aperture save for the emission of the water jet;
d) the support plate having a predetermined number of suction apertures passing through the working surface area and arranged in a pattern across the working surface area that surrounds the cutting aperture; and,
f) suction means for applying suction through the suction apertures to draw the web towards the suction apertures and into engagement with the working surface area, and the suction applied by the suction means preventing fluttering movement of the web relative to the working surface area to permit the water jet passing through the cutting aperture to cut through the web to form cut edges and to prevent wetting of the web and cut edges notwithstanding whether the web is normally travelling in the first direction or is remaining stationary relative to the working surface area of the slitting apparatus.

6. The water jet web slitting apparatus of claim 5 wherein the pattern of suction apertures is a symmetrical pattern providing substantially uniform suction force on the web over the working surface area and around the cutting aperture.

7. The water jet web slitting apparatus of claim 6 wherein the working surface area has a longitudinal working surface section downstream from the cutting aperture in the first direction of web travel whereby no suction is applied between the web cut edges.

8. The water jet web slitting apparatus of claim 6 wherein the suction apertures have a diameter that is considerably larger than the water jet cutting aperture.

9. The water jet web slitting apparatus of claim 6 wherein the working surface area has a perimeter within which the web is supported and the pattern of suction apertures extends outwardly from the cutting aperture to the perimeter of the working surface area.

10. A water jet web slitting apparatus for slitting a web normally travelling relative to the slitting apparatus and capable of remaining stationary relative to the slitting apparatus into a plurality of webs of smaller width, comprising:
a support beam traversing the width of the web;
a plurality of support arms carrying a water jet cutter and mounted along the support beam to define the width of the smaller webs to be cut;
the water jet cutter comprising:
a) a support plate having a working surface area against which the web is supported, the support plate having a cutting aperture passing through the working surface area and a predetermined number of suction apertures passing through the working surface area arranged in a pattern on both sides of the cutting aperture in the first direction of web travel;
b) a water jet nozzle located adjacent the cutting aperture for directing a water jet through the cutting aperture and away from the working surface area; and,
c) suction means for applying suction through the suction apertures to draw the web towards the suction apertures and into engagement with the working surface area whereby the web is supported by the support plate on upstream, downstream and on both sides of the cutting aperture in the first direction of web travel, and the suction applied by the suction means preventing fluttering movement of the web relative to the working surface area to permit the water jet passing through the cutting aperture to cut through the web to form cut edges and to prevent wetting of the web surface and cut edges notwithstanding whether the web is normally travelling in the first direction or is remaining stationary relative to the working surface area of the slitting apparatus.

11. The water jet web slitting apparatus of claim 10 wherein the pattern of suction apertures is uniform and substantially in a symmetrical pattern providing substantially uniform suction force on the web over the working surface area and around the cutting aperture.

12. The water jet web slitting apparatus of claim 11 wherein the working surface area has a longitudinal working surface section downstream from the cutting aperture in the first direction of web travel whereby no suction is applied between the web cut edges.

13. The water jet web slitting apparatus of claim 12 wherein the suction apertures have a diameter that is considerably larger than the water jet cutting aperture.

14. The water jet web slitting apparatus of claim 10 wherein the water jet nozzle substantially blocks the cutting aperture save for continuous emission of the water jet.

15. The water jet web slitting apparatus of claim 1 wherein the support plate has a front wall, two side walls, a back wall and a top wall defining a chamber into which suction is applied to draw a negative pressure through the suction apertures; and the back wall sloping outwardly away from the top wall to the support plate in the first direction of web travel.

16. The water jet web slitting apparatus of claim 5 wherein the support plate has a front wall, two side walls, a back wall and a top wall defining a chamber into which suction is applied to draw a negative pressure through the suction apertures; and the back wall sloping outwardly away from the top wall to the support plate in the first direction of web travel.

17. The water jet web slitting apparatus of claim 10 wherein the support plate has a front wall, two side walls, a back wall and a top wall defining a chamber into which suction is applied to draw a negative pressure through the suction apertures; and the back wall sloping outwardly away from the top wall to the support plate in the first direction of web travel.
